(19) United States
(12) Patent Application Publication
(10) Pub. No.: US 2007/0133798 A1
(43) Pub. Date: Jun. 14, 2007

(54) Quantum cryptography on a multi-drop optical network

(76) Inventor: Brig Barnum Elliott, Arlington, MA (US)

Correspondence Address: HARRITY SNYDER, LLP, 11350 Random Hills Road, SUITE 600, FAIRFAX, VA, 22030, US

(21) Appl. No.: 11/302,331

(22) Filed: Dec. 14, 2005

(51) Int. Cl. H04L 9/28; H04B 10/04; H04K 1/00; H04L 9/00; H04B 10/12

(52) U.S. Cl. 380/255; 380/28; 398/182; 398/189

(57) ABSTRACT

A system includes an optical network unit and a head-end or central office connected to a multi-drop optical network. The optical network unit transmits dim optical pulses via the multi-drop optical network using quantum cryptographic mechanisms to distribute encryption key symbols, where the dim optical pulses include one of single-photon optical pulses or weak attenuated optical pulses. The head-end or central office detects the dim optical pulses from the optical network unit, derives the encryption key symbols from the detected dim optical pulses, and encrypts data transmitted to the optical network unit using the encryption key symbols.

### GOVERNMENT CONTRACT

The U.S. Government has a paid-up license in this invention and the right in limited circumstances to require the patent owner to license others on reasonable terms as provided for by the terms of Contract No. F30602-01-C-0170, awarded by the Defense Advanced Research Project Agency (DARPA).

### FIELD OF THE INVENTION

The present invention relates generally to cryptographic systems and, more particularly, to cryptographic systems employing quantum cryptography.

### BACKGROUND OF THE INVENTION

Within the field of cryptography, it is well recognized that the strength of any cryptographic system depends on, among other things, the key distribution technique employed. For conventional encryption to be effective, such as a symmetric key system, two communicating parties must share the same key and that key must be protected from access by others. The key must, therefore, be distributed to each of the parties. FIG. 1 shows one form of a conventional key distribution process. As shown in FIG. 1, for a party, Bob, to decrypt ciphertext encrypted by a party, Alice or a third party must share a copy of the key with Bob. This distribution process can be implemented in a number of conventional ways including the following: 1) Alice can select a key and physically deliver the key to Bob; 2) a third party can select a key and physically deliver the key to Bob; 3) if Alice and Bob both have an encrypted connection to a third party, the third party can deliver a key on the encrypted links to Alice and Bob; 4) if Alice and Bob have previously used an old key, Alice can transmit a new key to Bob by encrypting the new key with the old; and 5) Alice and Bob may agree on a shared key via a one-way mathematical algorithm, such as Diffie-Helman key agreement. All of these distribution methods are vulnerable to interception of the distributed key by an eavesdropper Eve, or by Eve “cracking” the supposedly one-way algorithm. Eve can eavesdrop and intercept or copy a distributed key and then subsequently decrypt any intercepted ciphertext that is sent between Bob and Alice. In conventional cryptographic systems, this eavesdropping may go undetected, with the result being that any ciphertext sent between Bob and Alice is compromised.

To combat these inherent deficiencies in the key distribution process, researchers have developed a key distribution technique called quantum cryptography. Quantum cryptography employs quantum systems and applicable fundamental principles of physics to ensure the security of distributed keys. Heisenberg's uncertainty principle mandates that any attempt to observe the state of a quantum system will necessarily induce a change in the state of the quantum system. Thus, when very low levels of matter or energy, such as individual photons, are used to distribute keys, the techniques of quantum cryptography permit the key distributor and receiver to determine whether any eavesdropping has occurred during the key distribution. Quantum cryptography, therefore, prevents an eavesdropper, like Eve, from copying or intercepting a key that has been distributed from Alice to Bob without a significant probability of Bob's or Alice's discovery of the eavesdropping.

A well known quantum key distribution scheme involves a quantum channel, through which Alice and Bob send keys using polarized or phase encoded photons, and a public channel, through which Alice and Bob send ordinary messages. Since these polarized or phase encoded photons are employed for quantum key distribution (QKD), they are often termed QKD photons. The quantum channel is a transmission medium that isolates the QKD photons from interaction with the environment. The public channel may include a channel on any type of communication network such as a Public Switched Telephone Network, the Internet, or a wireless network. An eavesdropper, Eve, may attempt to measure the photons on the quantum channel. Such eavesdropping, however, will induce a measurable disturbance in the photons in accordance with the Heisenberg uncertainty principle. Alice and Bob use the public channel to discuss and compare the photons sent through the quantum channel. If, through their discussion and comparison, they determine that there is no evidence of eavesdropping, then the key material distributed via the quantum channel can be considered completely secret.

FIG. 2 illustrates a well-known scheme 200 for quantum key distribution in which the polarization of each photon is used for encoding cryptographic values. To begin the quantum key distribution process, Alice generates random bit values and bases 205 and then encodes the bits as polarization states (e.g., 0°, 45°, 90°, 135°) in sequences of photons sent via the quantum channel 210 (see row 1 of FIG. 3). Alice does not tell anyone the polarization of the photons she has transmitted. Bob receives the photons and measures their polarization along either a rectilinear or diagonal basis with randomly selected and substantially equal probability. Bob records his chosen basis (see row 2 of FIG. 3) and his measurement results (see row 3 of FIG. 3). Bob and Alice discuss 215, via the public channel 220, which basis he has chosen to measure each photon. Bob, however, does not inform Alice of the result of his measurements. Alice tells Bob, via the public channel, whether he has made the measurement along the correct basis (see row 4 of FIG. 3). In a process called “sifting” 225, both Alice and Bob then discard all cases in which Bob has made the measurement along the wrong basis and keep only the ones in which Bob has made the measurement along the correct basis (see row 5 of FIG. 3).

Alice and Bob then estimate 230 whether Eve has eavesdropped upon the key distribution. To do this, Alice and Bob must agree upon a maximum tolerable error rate. Errors can occur due to the intrinsic noise of the quantum channel and due to eavesdropping attack by a third party. Alice and Bob choose randomly a subset of photons m from the sequence of photons that have been transmitted and measured on the same basis. For each of the m photons, Bob announces publicly his measurement result. Alice informs Bob whether his result is the same as what she had originally sent. They both then compute the error rate of the m photons and, since the measurement results of the m photons have been discussed publicly, the polarization data of the m photons are discarded. If the computed error rate is higher than the agreed upon tolerable error rate (typically no more than about 15%), Alice and Bob infer that substantial eavesdropping has occurred. They then discard the current polarization data and start over with a new sequence of photons. If the error rate is acceptably small, Alice and Bob adopt the remaining polarizations, or some algebraic combination of their values, as secret bits of a shared secret key 235, interpreting horizontal or 45 degree polarized photons as binary 0's and vertical or 135 degree photons as binary 1's (see row 6 of FIG. 3). Conventional error detection and correction processes, such as parity checking or convolutional encoding, may further be performed on the secret bits to correct any bit errors due to the intrinsic noise of the quantum channel.

Alice and Bob may also implement an additional privacy amplification process 240 that reduces the key to a small set of derived bits to reduce Eve's knowledge of the key. If, subsequent to discussion 215 and sifting 225, Alice and Bob adopt n bits as secret bits, the n bits can be compressed using, for example, a hash function. Alice and Bob agree upon a publicly chosen hash function ƒ and take K=ƒ(n bits) as the shared r-bit length key K. The hash function randomly redistributes the n bits such that a small change in bits produces a large change in the hash value. Thus, even if Eve determines a number of bits of the transmitted key through eavesdropping, and also knows the hash function ƒ, she still will be left with very little knowledge regarding the content of the hashed r-bit key K. Alice and Bob may further authenticate the public channel transmissions to prevent a “man-in-the-middle” attack in which Eve masquerades as either Bob or Alice.

### SUMMARY OF THE INVENTION

In accordance with the purpose of the invention as embodied and broadly described herein, a method may include receiving dim optical pulses from multiple subscriber units at a head-end or central office via a multi-drop optical network, where the dim optical pulses include one of single-photon optical pulses or weak, attenuated optical pulses. The method may further include detecting the dim optical pulses at the head-end or central office.

Consistent with a further aspect of the invention, a method may include determining transmission schedules for multiple optical network units connected to an optical line terminal via a multi-drop optical network and disseminating the transmission schedules to the multiple optical network units. The method may further include receiving, at times corresponding to the disseminated transmission schedules, encryption key symbols from the multiple optical network units via the multi-drop optical network using quantum cryptographic techniques.

Consistent with another aspect of invention, a method may include receiving permission to access an uplink from an optical line terminal and transmitting data to the optical line terminal via a first uplink optical channel. The method may further include transmitting encryption key symbols to the optical line terminal via a second uplink optical channel that is different than the first uplink optical channel.

Consistent with yet another aspect of the invention, a method may include obtaining data for transmission to a head-end or central office and obtaining encryption key symbols for transmission to the head-end or central office. The method may further include multiplexing dim optical pulses with bright optical pulses on an optical link connected to the head-end or central office, where the dim optical pulses include single-photon or weak attenuated optical pulses that are encoded with the encryption key symbols and where the bright optical pulses include optical pulses having a large number of photons and which convey the obtained data.

### BRIEF DESCRIPTION OF THE DRAWINGS

The accompanying drawings, which are incorporated in and constitute a part of this specification, illustrate one or more exemplary embodiments of the invention and, together with the description, explain the invention. In the drawings,

FIG. 1 illustrates existing cryptographic key distribution and ciphertext communication;

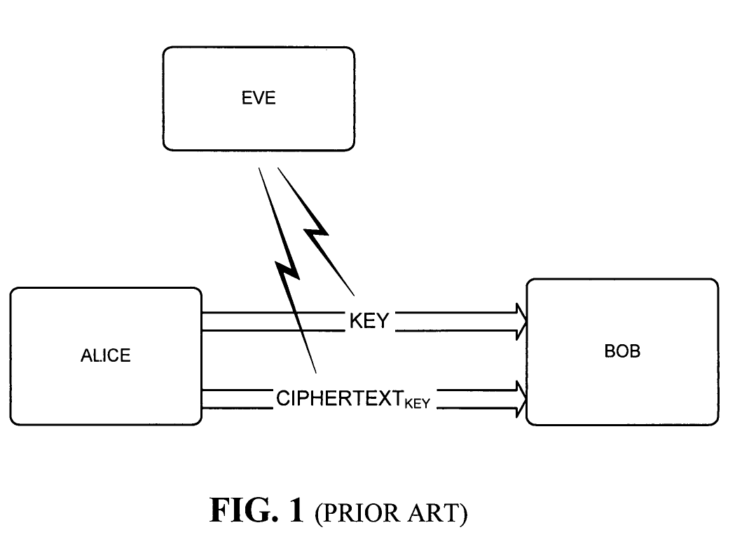

FIG. 2 illustrates an existing quantum cryptographic key distribution (QKD) process;

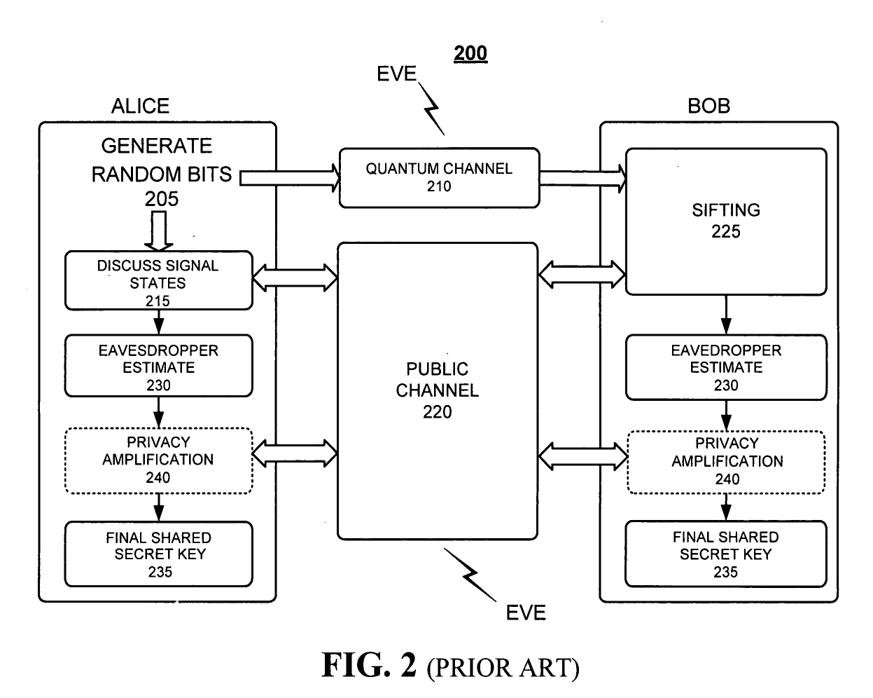

FIG. 3 illustrates an existing quantum cryptographic sifting and error correction process;

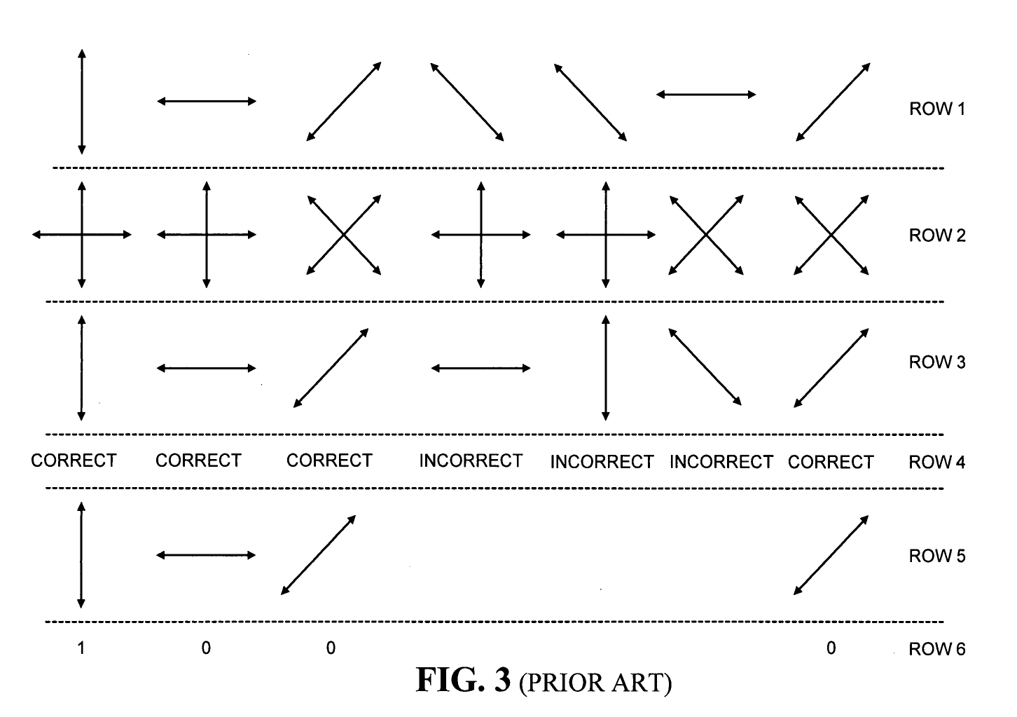

FIG. 4 illustrates an exemplary network implementation consistent with principles of invention;

FIG. 5 illustrates exemplary details of quantum key distribution between optical network units and the optical line terminal of FIG. 4 consistent with principles of the invention;

FIG. 6 illustrates uplink and downlink communication between the optical line terminal and optical network units of FIG. 4 consistent with principles of the invention;

FIG. 7 illustrates further details of uplink communication between optical network units and the optical line terminal of FIG. 4 consistent with principles of the invention;

FIG. 8 illustrates further details of downlink communication between the optical line terminal and optical network units of FIG. 4 consistent with principles of the invention;

FIG. 9 illustrates an exemplary configuration of head-end/central office of FIG. 4 consistent with principles of the invention;

FIG. 10 illustrates an exemplary configuration of a subscriber unit of FIG. 4 consistent with principles of the invention;

FIG. 11 illustrates a high-level diagram of an exemplary dim optical pulse transmitter consistent with principles of the invention;

FIG. 12 illustrates a high-level diagram of an exemplary dim optical pulse receiver consistent with principles of the invention;

FIG. 13 illustrates details of one exemplary implementation of the dim optical pulse transmitter of FIG. 11 consistent with principles of the invention;

FIG. 14 illustrates details of one exemplary implementation of the dim optical pulse receiver of FIG. 12 consistent with principles of the invention;

FIG. 15 is a diagram illustrating exemplary relationships between bright and dim optical pulses and framing at the dim optical pulse transmitter and receiver;

FIGS. 16A-16C are diagrams that illustrate exemplary symbols used to encode QKD framing information consistent with principles of the invention;

FIG. 17 is a diagram illustrating an exemplary frame structure consistent with principles of the invention;

FIG. 18 is a flow chart that illustrates an exemplary process for channel access by an optical line terminal to transmit downlink data to optical network units and to receive uplink data and encryption key symbols from the optical network units; and

FIG. 19 is a flow chart that illustrates an exemplary process for uplink channel access between an optical network unit and optical line terminal.

### DETAILED DESCRIPTION

The following detailed description of the invention refers to the accompanying drawings. The same reference numbers in different drawings identify the same or similar elements. Also, the following detailed description does not limit the invention. Instead, the scope of the invention is defined by the appended claims.

Systems and methods consistent with principles of the invention implement quantum cryptography in multi-drop optical networks to provide a high level of data security. “Next generation” local telecommunication infrastructure (e.g., “last mile,” central office to subscriber, cable head-end to subscriber) is expected to include multi-drop optical networks connected to every home in the United States. Aspects of the invention may be used to provide quantum cryptographic security protection for local network service, such as, for example, phone calls, Internet browsing, or pay-per-view movies, between a subscriber residence and a local central office, or head-end, across a shared local multi-drop optical network.

### EXEMPLARY NETWORK IMPLEMENTATION

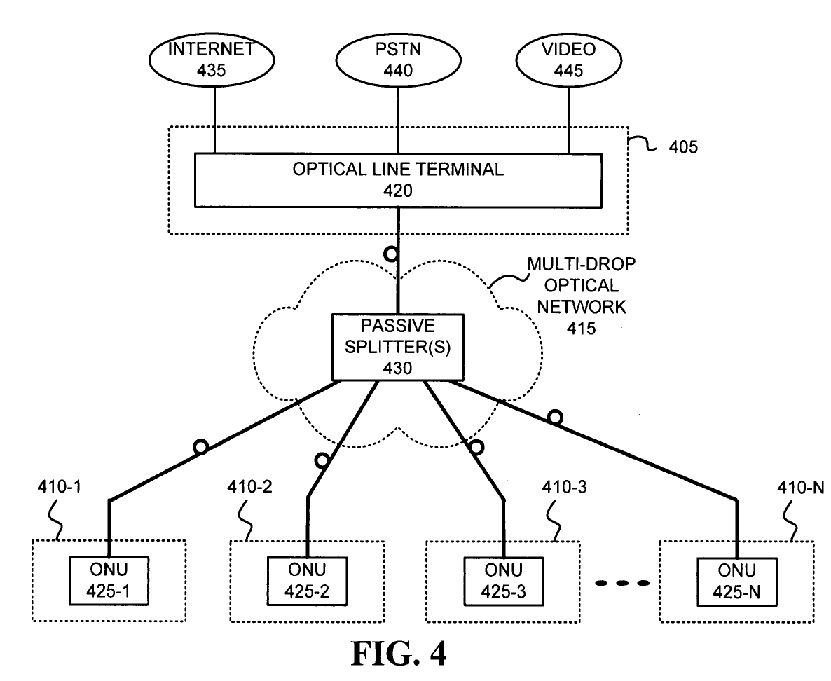

FIG. 4 illustrates an exemplary implementation, consistent with principles of the invention, in which quantum cryptographic key distribution is implemented within a multi-drop network. The exemplary implementation shown in FIG. 4 may include a head-end device 405 connected with multiple subscriber units 410-1 through 410-N via a multi-drop optical network 415. In some implementations, head-end device 405 may alternatively include a local central office (CO). Head-end device 405 may include an optical line terminal (OLT) 420. Subscriber units 410-1 through 410-N may each include a respective optical network unit (ONU) 425-1 through 425-N.

In one implementation, multi-drop optical network 415 may include a Passive Optical Network (PON) and, thus, may include one or more passive optical splitters 430. PONs typically do not have active electronics in the local network itself (e.g., on telephone poles), but instead includes all electronics in the head-end/local exchange and on the subscriber premises. PONs typically use passive optical splitting for interconnecting network links. The PON may include any type of existing PON, such as, for example, an ATM based PON, an Ethernet based PON, a broadband PON or a gigabit PON. Implementations of the invention, thus, may leverage the channel access scheme used by the PON for conveying dim optical pulses for QKD.

As illustrated in FIG. 4, optical line terminal 420 may connect with ONUs 425-1 through 425-N (collectively referred to herein as ONU 425) via passive optical splitters 430 of network 415. The links between optical line terminal 420 and passive splitter(s) 430, and between passive splitter(s) 430 and ONUs 425-1 through 425-N may carry light throughout the electromagnetic spectrum, including light in the human visible spectrum and light beyond the human-visible spectrum, such as, for example, infrared or ultraviolet light. In one implementation, the links may include optical fiber links. In a further implementation, one or more of the links between optical line terminal 420 and passive splitter(s) 430, and between passive splitter(s) 430 and ONUs 425-1 through 425-N may include free-space links. The free-space links may include free-space optical paths, such as, for example, paths through the atmosphere or outer space, or even through water or other transparent media. In an additional implementation, the interconnections may include hollow optical fiber that may be lined with photonic band-gap material.

As further shown in FIG. 4, optical line terminal 420 may connect with various other networks, such as, for example, the Internet 435, a public switched telephone network (PSTN) 440 or a video network 445.

ONUs 425-1 through 425-N may distribute quantum cryptographic keys to optical line terminal 420 via multi-drop optical network 415. ONUs 425-1 through 425-N may distribute quantum cryptographic keys using, for example, quantum cryptographic systems employing single-photon, or attenuated, optical pulses. Subsequent to quantum key distribution via multi-drop optical network 415, OLT 420 may subsequently encrypt data sent to ONUs 425-1 through 425-N using the encryption keys distributed using QKD.

It will be appreciated that the number of components illustrated in FIG. 4 is provided for explanatory purposes only. A typical network may include more or fewer components than are illustrated in FIG. 4.

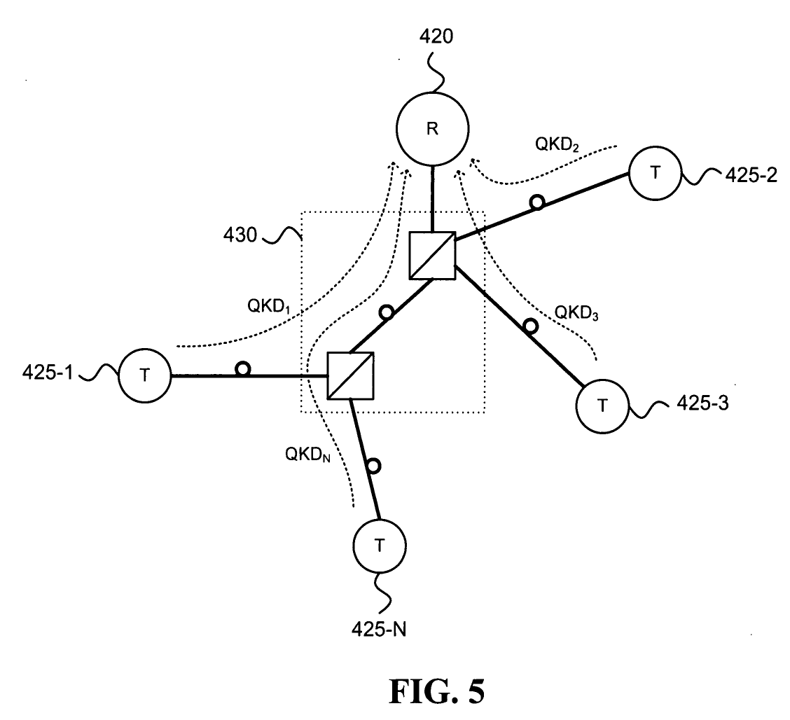

FIG. 5 illustrates exemplary details of quantum key distribution between ONUs 425-1 through 425-N and OLT 420. As shown, each ONU 420 includes an optical transmitter (T) for transmitting dim optical pulses to OLT 420 via passive splitter(s) 430 to distribute encryption key symbols using quantum cryptographic key distribution. Each optical transmitter (T) may include photon sources that produce single-photon optical pulses (i.e., optical pulses containing only a single photon), or weak attenuated optical pulses (i.e., optical pulses containing a very small number of photons). OLT 420 includes an optical receiver (R) for detecting the dim optical pulses transmitted from the ONUs 425-1 through 425-N. Subsequent to receiving the encryption keys from each ONU 425, OLT 420 may encrypt data sent to each ONU 425 using a corresponding encryption key received from the respective ONU 425 via QKD.

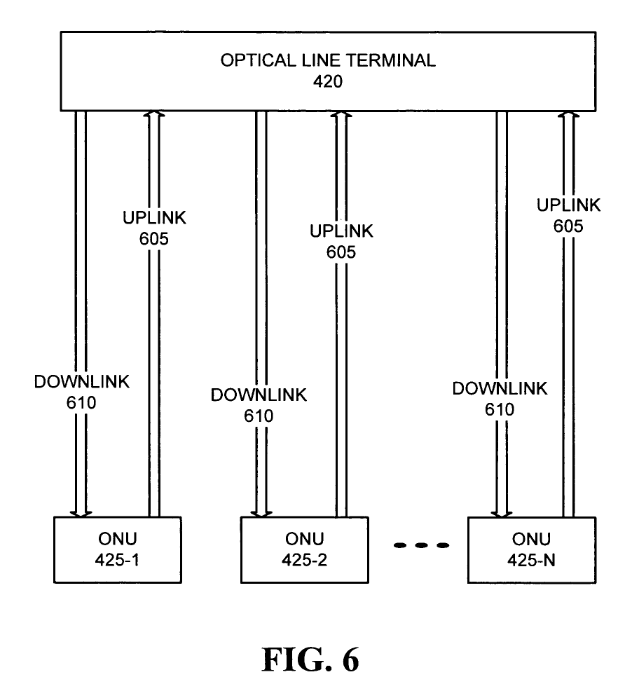

FIG. 6 further illustrates uplink and downlink communication between OLT 420 and ONUs 425-1 through 425-N. During the uplink 605 from an ONU 425 to OLT 420, dim QKD optical pulses may be transmitted in parallel with bright data pulses to OLT 420. The dim QKD optical pulses may be encoded with encryption key symbols. The bright data pulses may convey data from an ONU 425 to OLT 420. The dim QKD optical pulses and the bright data pulses on the uplink 605 may be transmitted over separate channels. Each channel may include a separate wavelength if Wavelength Division Multiplexing (WDM) is employed, or a time slot if Time Division Multiplexing (TDM) is employed. The separate channels may also include combinations of TDM and WDM. On the uplink 605, an ONU 425 may send a data frame to the OLT on a first channel, while sending a series of dim QKD optical pulses on a different channel. OLT 420 may subsequently encrypt data traffic on the downlink 610 to a respective ONU 425. Thus, for example, if ONU 425-1 distributes an encryption key via dim QKD pulses on the uplink 605 to OLT 420, OLT 420 may subsequently encrypt traffic on the downlink 610 to ONU 425-1 using the distributed encryption key. Similarly, OLT 420 may encrypt traffic to other ONUs 425 using encryption keys distributed by respective ONUs 425 using dim QKD pulses.

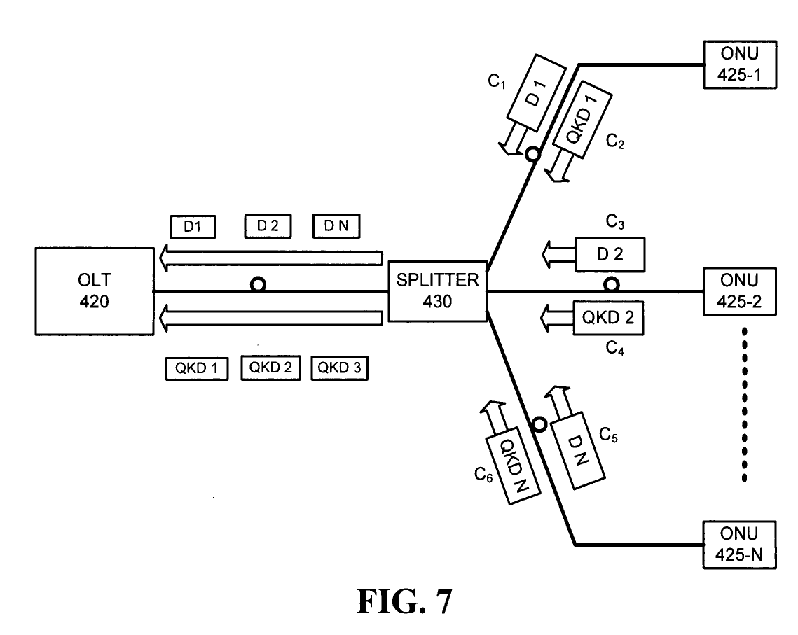

FIG. 7 illustrates further details of uplink communication between ONUs 425-1 through 425-N and OLT 420. As shown in FIG. 7, ONU 425-1 may transmit data (D1) over a first channel (C₁), and QKD symbols (QKD 1) over a second channel (C₂), to OLT 420 via splitter 430. Channel C₁ may represent a different wavelength, in a WDM transmission scheme, or a different timeslot, in a TDM transmission scheme, as compared to channel C₂. Alternatively, channel C1 may represent a different wavelength and a different timeslot, in a combined WDM/TDM transmission scheme, as compared to channel C₂. Data D 1 may be transmitted from ONU 425-1 using bright optical pulses, while QKD symbols QKD 1 may be transmitted from ONU 425-1 using dim optical pulses.

ONU 425-2 may further transmit data (D 2) over a third channel (C₃), and QKD symbols (QKD 2) over a fourth channel (C₄), to OLT 420 via splitter 430. Channel C₃ may represent a different wavelength, in a WDM transmission scheme, or a different timeslot, in a TDM transmission scheme, as compared to channel C₄. Alternatively, channel C₃ may represent a different wavelength and different timeslot, in a combined WDM/TDM transmission scheme, as compared to channel C₄. Data D 2 may be transmitted from ONU 425-2 using bright optical pulses, while QKD symbols QKD 2 may be transmitted from ONU 425-2 using dim optical pulses.

ONU 425-N may transmit data (D N) over a fifth channel (C₅), and QKD symbols (QKD N) over a sixth channel (C₆), to OLT 420 via splitter 430. Channel C₅ may represent a different wavelength, in a WDM transmission scheme, or a different timeslot, in a TDM transmission scheme, as compared to channel C₆. Alternatively, channel C₅ may represent a different wavelength and different timeslot, in a combined WDM/TDM transmission scheme, as compared to channel C₆. Data D N may be transmitted from ONU 425-N using bright optical pulses, while QKD symbols QKD N may be transmitted from ONU 425-N using dim optical pulses.

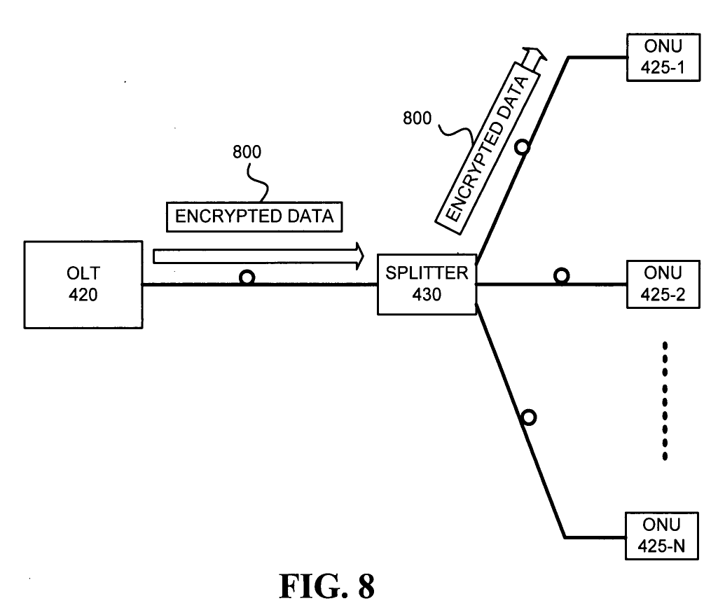

FIG. 8 illustrates further details of downlink communication between OLT 420 to ONU 425-1. As shown in FIG. 8, OLT 420 may transmit encrypted data 800, encrypted using an encryption key derived from QKD symbols (QKD 1) received from ONU 425-1 using dim optical pulses, on the downlink to ONU 425-1. The channel used for downlink transmission from OLT 420 may be the same as or different than that used for upstream communication from ONUs 425-1 through 425-N.

### EXEMPLARY HEAD-END

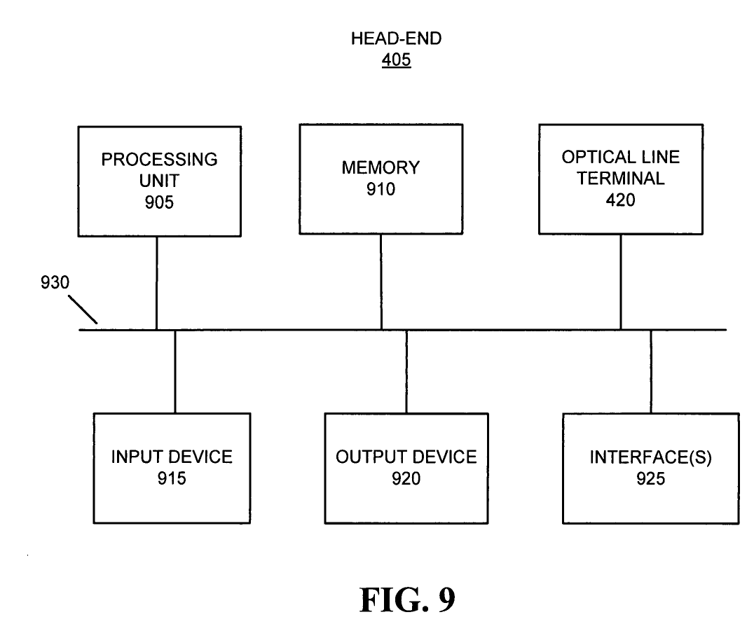

FIG. 9 illustrates exemplary components of a head-end 405 consistent with principles of the invention. Head-end 405 may include a processing unit 905, a memory 910, an input device 915, an output device 920, an OLT 420, a network interface(s) 925, and a bus 930. Processing unit 905 may perform all data processing functions for inputting, outputting, and processing of head-end data. Memory 910 may include Random Access Memory (RAM) that provides temporary working storage of data and instructions for use by processing unit 905 in performing processing functions. Memory 910 may additionally include Read Only Memory (ROM) that provides permanent or semi-permanent storage of data and instructions for use by processing unit 905. Memory 910 can also include large-capacity storage devices, such as a magnetic and/or optical recording medium and its corresponding drive.

Input device 915 permits entry of data into head-end 405 and may include a user interface (not shown). Output device 920 permits the output of data in video, audio, and/or hard copy format. OLT 420 may include existing mechanisms for transmitting and receiving bright optical pulses for normal data transmission to and from ONUs 425-1 through 425-N, and mechanisms for receiving dim optical pulses for QKD from ONUs 425-1 through 425-N (as will be described further below).

Network interface(s) 925 may interconnect head-end 405 with Internet 435, PSTN 440 or video network 445. Bus 930 may interconnect the various components of head-end 405 to permit the components to communicate with one another.

### EXEMPLARY SUBSCRIBER UNIT

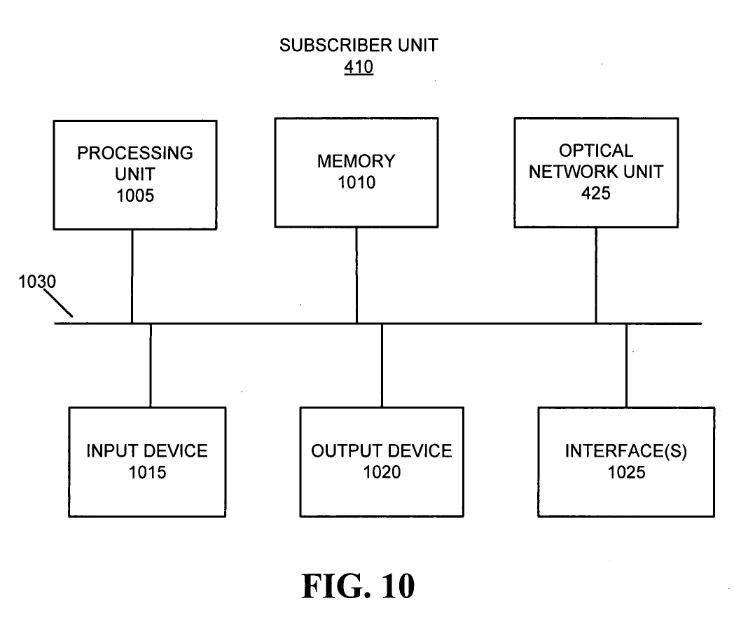

FIG. 10 illustrates exemplary components of a subscriber unit 410 consistent with principles of the invention. Subscriber unit 410 may include a processing unit 1005, a memory 1010, an input device 1015, an output device 1020, an ONU 425, a network interface(s) 1025, and a bus 1030. Processing unit 1005 may perform all data processing functions for inputting, outputting, and processing of subscriber unit data. Memory 1010 may include a RAM that provides temporary working storage of data and instructions for use by processing unit 1005 in performing processing functions. Memory 1010 may additionally include a ROM that provides permanent or semi-permanent storage of data and instructions for use by processing unit 1005. Memory 1010 can also include large-capacity storage devices, such as a magnetic and/or optical recording medium and its corresponding drive.

Input device 1015 permits entry of data into subscriber unit 410 and may include a user interface (not shown). Output device 1020 permits the output of data in video, audio, and/or hard copy format. ONU 425 may include existing mechanisms for transmitting and receiving bright optical pulses for normal data transmission to and from OLT 420, and mechanisms for transmitting dim optical pulses for QKD to OLT 420 (as will be described further below). Network interface(s) 1025 may interconnect subscriber unit 410 with other networks, such as, for example, Internet 435. Bus 1030 may interconnect the various components of subscriber unit 410 to permit the components to communicate with one another.

### EXEMPLARY ONU DIM OPTICAL PULSE TRANSMITTER

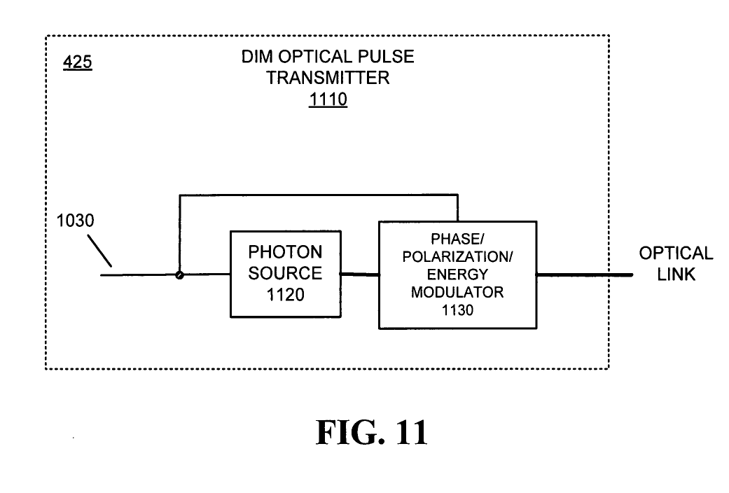

FIG. 11 illustrates a high-level diagram of a dim optical pulse transmitter 1110 of an ONU 425 consistent with principles of the invention. Each ONU 425 may additionally include a bright optical pulse transmitter (not shown) for transmitting other data to OLT 420. Dim optical pulse transmitter 1110 may include a photon source 1120 and a phase/polarization/energy modulator 1130. Photon source 1120 can include, for example, a laser that, in conjunction with other components, produces dim optical pulses for QKD. The dim optical pulses may include single-photon optical pulses or weak, attenuated optical pulses. Photon source 1120 may produce dim optical pulses according to instructions provided by processing unit 1005. Photon source 1120 may produce dim optical pulses of light with wavelengths throughout the electromagnetic spectrum, including light in the human visible spectrum and light beyond the human-visible spectrum, such as, for example, infrared or ultraviolet light. Phase/polarization/energy modulator 1130 can include, for example, Mach-Zehnder interferometers. Phase/polarization/energy modulator 1130 may encode outgoing photons from photon source 1120 according to commands received from processing unit 1005 for transmission across an optical link or network, such as multi-drop optical network 415.

### EXEMPLARY OLT DIM OPTICAL PULSE RECEIVER

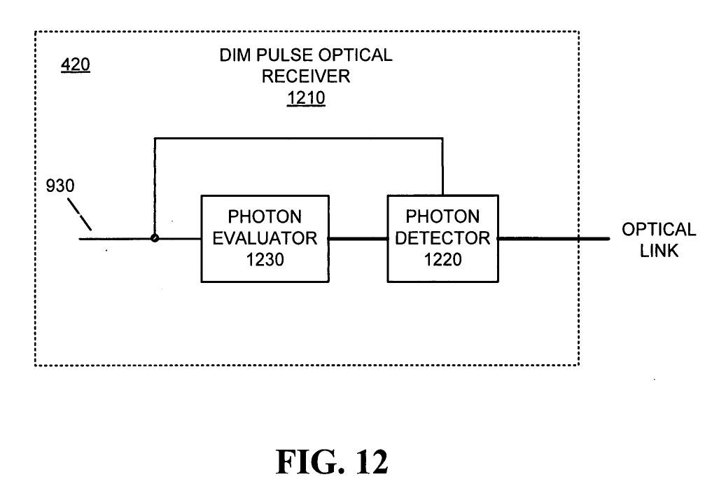

FIG. 12 illustrates a high-level diagram of a dim optical pulse receiver 1210 of an OLT 420 consistent with principles of the invention. Dim optical pulse receiver 1210 may include a photon detector 1220 and a photon evaluator 1230. Photon detector 1220 can include, for example, one or more avalanche photo detectors (APDs) and/or photo-multiplier tubes (PMTs) that can detect dim optical pulses (i.e., single-photon optical pulses, or weak, attenuated optical pulses). Photon detector 1220 may also include, for example, cryogenically cooled detectors that sense energy via changes in detector temperature or electrical resistivity as photons strike the detector apparatus. Photon detector 1220 can detect photons received across multi-drop optical network 415. Photon evaluator 1230 may include circuitry for processing and evaluating output signals from photon detector 1220 in accordance with quantum cryptographic techniques.

### EXEMPLARY COMPONENTS OF DIM OPTICAL PULSE TRANSMITTER

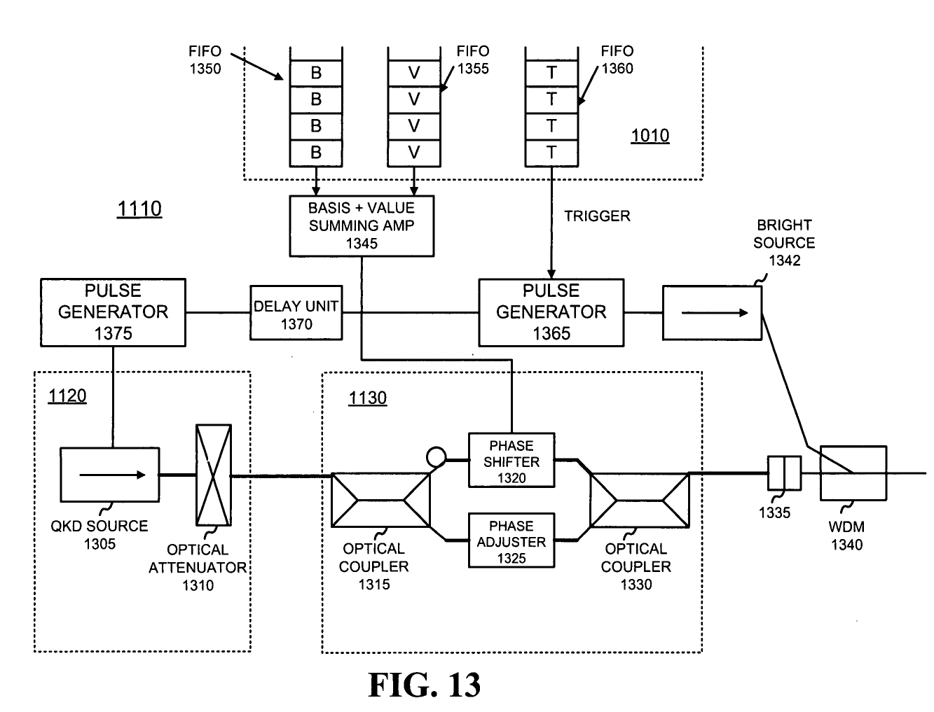

FIG. 13 illustrates exemplary components of one implementation of dim pulse optical transmitter 1110 consistent with principles of the invention. Transmitter 1110 may include photon source 1120 and phase modulator 1130. Photon source 1120 may include a QKD source 1305 and an optical attenuator 1310. Phase modulator 1130 may include an optical coupler 1315, a phase shifter 1320, a phase adjuster 1325, and an optical coupler 1330. Transmitter 1110 may further include a fiber adapter 1335, a wavelength division multiplexer (WDM) 1340, a bright source 1342, a summing amp 1345, multiple First-in-First-Out (FIFO) queues 1350, 1355 and 1360 of memory 1010, a pulse generator 1365, a delay unit 1370, and a pulse generator 1375.

QKD source 1305 may include a laser that produces photon pulses at, for example, 1550 nm wavelength. The number of photons contained in each photon pulse produced by QKD source 1305 may be statistically distributed according to, for example, a Poisson distribution. According to such a statistical distribution, a series of photon pulses emitted by QKD source 1305, when attenuated by optical attenuator 1310, may include less than a threshold level of photons per pulse on average (e.g., less than 1 photon/pulse). Optical coupler 1315 may include, for example, a 50/50 coupler, and may couple dim photon pulses from QKD source 1305 to both phase shifter 1320 and phase adjuster 1325. Phase shifter 1320 and phase adjuster 1325 may include a Mach-Zehnder interferometer that is modulated to one of four phases to encode both a basis value and a cryptographic key symbol value in each photon's self interference. For example, a cryptographic key symbol of “0” or “1” may be encoded in either of two randomly selected non-orthogonal bases. In one implementation, the “0” key symbol can be encoded by either a phase shift of 0 (basis 0) or π/2 (basis 1) and the “1” key symbol can be encoded by either a π phase shift (basis 0) or a 3π/2 phase shift (basis 1). Four different basis and key symbol pairs (basis, symbol) may, thus, be encoded by four different phase shifts (0, π/2, π, or 3π/2). This may be achieved by applying four different voltages to phase shifter 1320. These voltages may be applied by summing amp 1345 which may convert a basis value B received from FIFO 1350 and a cryptographic key value V received from FIFO 1355 to one of four different voltages for inducing a corresponding phase shift in phase shifter 1320. Phase adjuster 1325 may maintain a stable path length during photon transmission and may maintain the identity of interferometers at transmitter 1110 and the receiver 1210.

Optical coupler 1330 may include, for example, a 50/50 coupler, and may couple the signals from phase shifter 1320 and phase adjuster 1325 to fiber adapter 1335. Fiber adapter 1335 may interconnect polarization maintaining fiber from optical coupler 1330 to non-polarization maintaining fiber coupled to WDM 1340. WDM 1340 may multiplex the dim photon pulses from QKD source 1305 with the bright photon pulses generated by bright source 1342. Bright source 1342 may include a laser that produces multi-photon pulses (e.g., bright pulses) at, for example, 1300 nm wavelength.

A series of trigger values T may be received from FIFO 1360 for triggering pulse generator 1365. When triggered, pulse generator 1365 may send a pulse to bright source 1342 for initiating the transmission of a bright pulse, and a pulse to delay unit 1370. Delay unit 1370 may delay the pulse from pulse generator 1365 a specified delay interval before passing the pulse on to pulse generator 1375. Upon receipt of the delayed pulse, pulse generator 1375 may send an electrical pulse to QKD source 1305 for initiating the transmission of a photon pulse that may be attenuated by optical attenuator 1310 to produce a dim photon pulse.

### EXEMPLARY COMPONENTS OF DIM OPTICAL PULSE RECEIVER

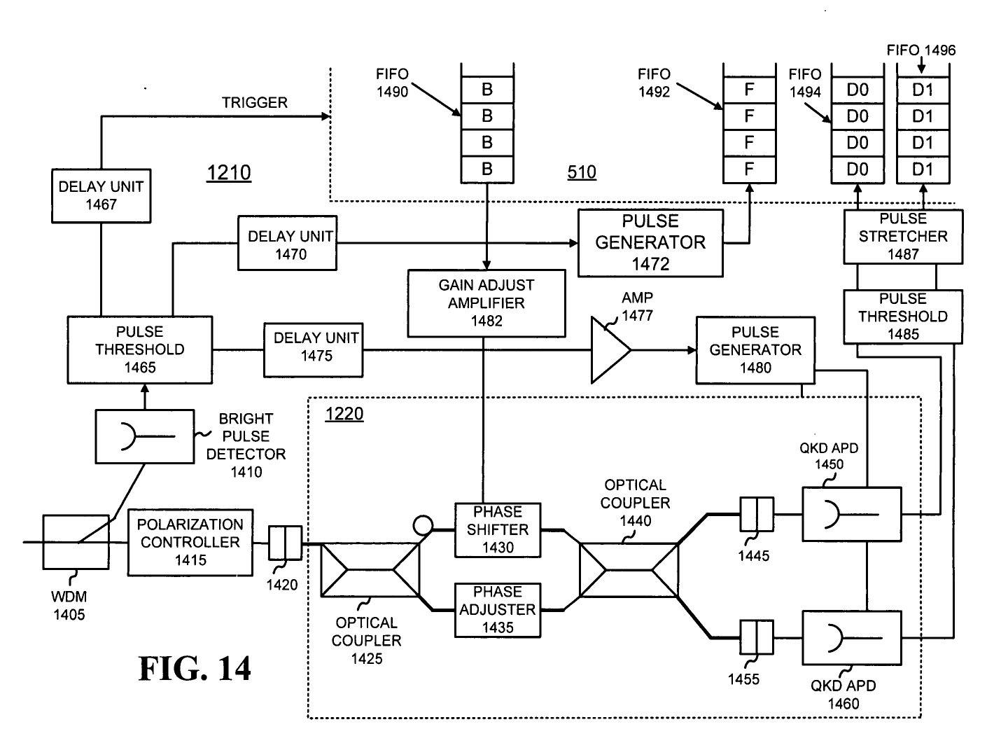

FIG. 14 illustrates exemplary components of one implementation of dim optical pulse receiver 1210 consistent with principles of the invention. Receiver 1210 may include a WDM 1405, a bright pulse detector 1410, a polarization controller 1415, a fiber adapter 1420, an optical coupler 1425, a phase shifter 1430, a phase adjuster 1435, an optical coupler 1440, a fiber adapter 1445, a QKD APD 1450, a fiber adapter 1455, and a QKD APD 1460. Receiver 1210 may further include a pulse threshold device 1465, delay units 1467 and 1470, a pulse generator 1472, a delay unit 1475, an amplifier 1477, a pulse generator 1480, a gain adjust amplifier 1482, a pulse threshold device 1485, a pulse stretcher 1487, and multiple FIFO's 1490, 1492, 1494 and 1496 of memory 910.

WDM 1405 may demultiplex optical pulses transmitted from dim optical pulse transmitter 1110 from an ONU 425. WDM 1405 may, for example, demultiplex bright pulses at 1300 nm wavelength to bright pulse detector 1410. WDM 1405 may further, for example, demultiplex dim pulses at 1550 nm wavelength to polarization controller 1415. Polarization controller 1415 may adjust the polarization of incoming dim pulse photons, which have had their polarization altered by transit across link multi-drop optical network 415, such that the photons exhibit uniform polarization. Fiber adapter 1420 may adapt non-polarization maintaining fiber coupled to polarization controller 1415 to polarization maintaining fiber coupled to optical coupler 1425. Optical coupler 1425 may provide dim pulses to phase shifter 1430 and phase adjuster 1435. A phase shift may be randomly applied to phase shifter 1430 via gain adjust amplifier 1482. Gain adjust amplifier 1482 may receive a basis value B from FIFO 1490 indicating either a 0-π basis or a π/2-3π/2 basis. Gain adjust amplifier 1482 may translate the basis value to an output voltage that adjusts the phase shift of phase shifter 1430 an amount corresponding to the output voltage. Phase adjuster 1435 may maintain a stable path length during photon transmission and reception and may maintain the identity of interferometers at the transmitting dim optical pulse transmitter 1110 and dim optical pulse receiver 1210.

Optical coupler 1440 may couple the signals from phase shifter 1430 and phase adjuster 1435 and provide the coupled signals to QKD APD 1450 via fiber adapter 1445, and to QKD APD 1460 via fiber adapter 1455. Fiber adapter 1445 may adapt polarization maintaining fiber coupled to a port of optical coupler 1440 to non-polarization maintaining fiber coupled to QKD APD 1450. Fiber adapter 1455 may adapt non-polarization maintaining fiber coupled to a port of optical coupler 1440 to non-polarization maintaining fiber coupled to QKD APD 1460.

Bright pulse detector 1410 may pass an electrical annunciator pulse, indicating receipt of a bright photon pulse, to pulse threshold device 1485. Pulse threshold device 1465 may provide a logic pulse for each bright pulse received at detector 1410 to trigger the gating of QKD APDs 1450 and 1460 via delay unit 1475, amplifier 1477 and pulse generator 1480. Delay unit 1475 may delay the logic pulse trigger from pulse threshold device 1465 a sufficient interval such that QKD APDs 1450 and 1460 are gated precisely at a time a subsequent dim photon pulse arrives. At the receipt of a dim photon pulse at either QKD APD 1450 or 1460, the outputs of the APDs are sampled by pulse threshold device 1385. Pulse threshold device 1485 provides a pulse corresponding to each APD 1450 and 1460 if their sampled outputs meet a specified threshold value. Pulse stretcher 1487 receives the corresponding pulse(s) from pulse threshold device 1485 and converts the received pulses to a logic high symbol (i.e., a pulse is received) or a logic low symbol (i.e., no pulse is received). Logic high or low symbols corresponding to the output (designated as D0) from QKD APD 1450 may be provided to FIFO 1494. Logic high or low symbols corresponding to the output (designated as D1) from QKD APD 1460 may be provided to FIFO 1496.

Pulse threshold device 1465 may further provide a logic pulse, corresponding to each received bright photon pulse, as a trigger to FIFOs 1490, 1492, 1494 and 1496 via delay unit 1467. The trigger may “clock” data in or out of each of the FIFOs. Pulse threshold device 1465 may further provide a logic pulse, via delay unit 1470, to trigger pulse generator 1472. Pulse generator 1472, responsive to a trigger pulse from pulse threshold device 1465, may pass a framing symbol F to FIFO 1492.

### EXEMPLARY QFRAME/PHOTON PULSE MAPPING

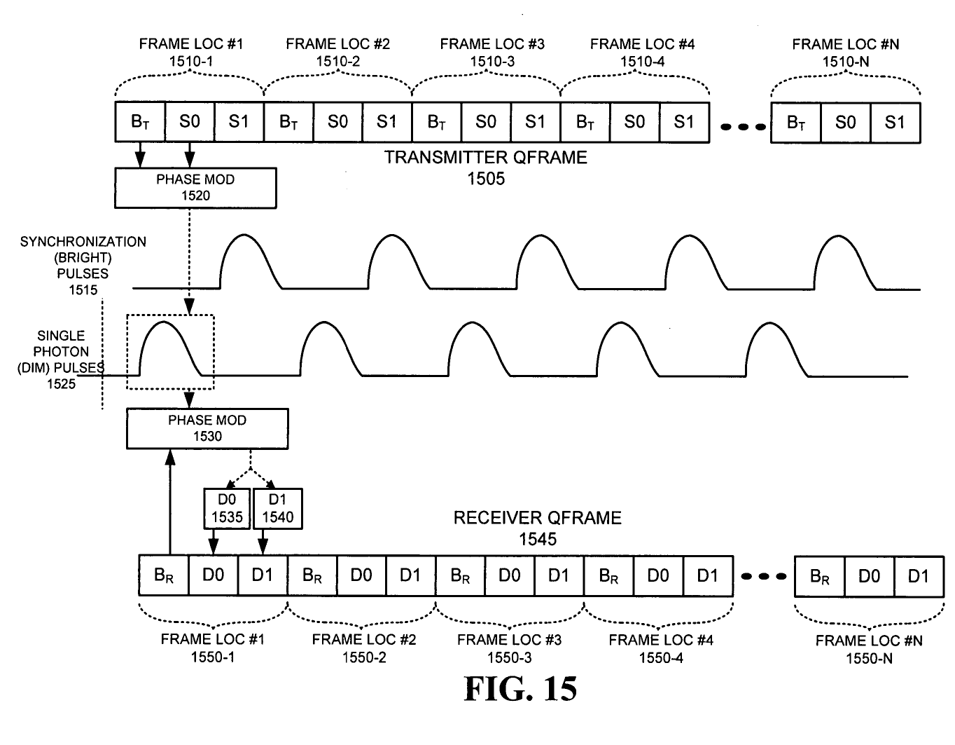

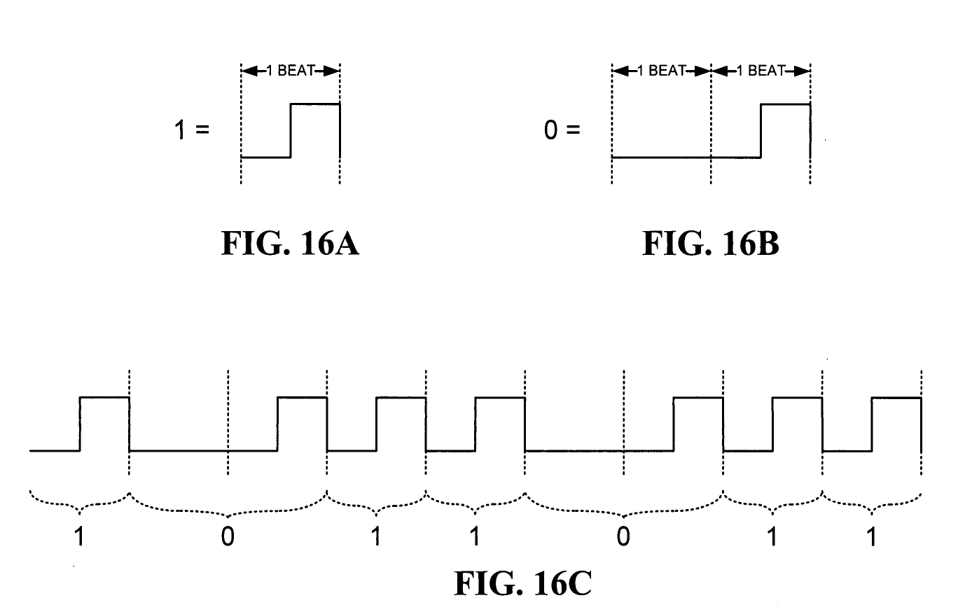

FIG. 15 illustrates an exemplary mapping between a Qframe 1505 transmitted at a dim optical pulse transmitter 1110, and a corresponding second Qframe 1545 received at a dim optical pulse receiver 1210, and bright and dim pulses transmitted by dim optical pulse transmitter 1110. Bright pulses 1515 may indicate synchronization timing and frame boundaries (as described in more detail below with respect to FIG. 16). Dim pulses 1525 may contain quantum cryptographic key symbols encoded via modulation of, for example, the phase of the dim photon pulse transmitted from dim optical pulse transmitter 1110.

A transmitter Qframe 1505 may include multiple frame locations (frame loc #1 1510-1 through frame loc #N 1510-N), each of which may include a number of symbol values. A frame length may determine the number of frame locations in transmitter Qframe 1505. The frame length may be fixed, or may vary with each frame. The symbols of each frame location may include a basis symbol B_{T}, a first symbol S0 and a second symbol S1. Basis value B_{T} may indicate one of two bases. A first basis may include a phase shift of 0 or π. A second basis may include a phase shift of π/2 or 3π/2. Symbols S0 and S1 may, together, indicate a quantum cryptographic key symbol. For example, S0 and S1 symbols of “01” may indicate a key symbol of “0.” As an additional example, S0 and S1 symbols of “10” may indicate a key symbol of “1.” Basis symbol B_{T} and each symbol S0 and S1 may be used to phase modulate 1520 an outgoing dim pulse 1525 from dim optical pulse transmitter 1110.

A receiver Qframe 1545 may include multiple frame locations (frame loc #1 1550-1 through frame loc #N 1550-N), each of which may include a number of symbol values. A frame length may determine the number of frame locations in receiver Qframe 1545. The frame length may be fixed, or may vary with each frame. The symbols of each frame location may include a basis symbol B_{R}, a first detected symbol D0 1535 and a second detected symbol D1 1540. Basis value B_{R} may indicate one of two bases. A first basis may include a phase shift of 0 or π. A second basis may include a phase shift of π/2 or 3π/2. Basis value B_{R} may be used to phase modulate 1530 a received dim pulse 1525. D0 1535 may indicate a symbol detected at QKD APD 1450 of dim optical pulse receiver 1210. D1 1540 may indicate a symbol detected at QKD APD 1460 of dim optical pulse receiver 1210.

### EXEMPLARY BRIGHT PULSE SYMBOL ENCODING

FIGS. 16A-16C illustrate exemplary bright photon pulse symbol encoding consistent with principles of the invention. As shown in FIG. 16A, a “1” symbol can be encoded by a rising edge of a bright photon pulse that is produced within a predetermined “beat” interval. As further shown in FIG. 16B, a “0” symbol can be encoded by a rising edge of a bright photon pulse that is delayed by at least one beat interval. Though FIG. 16B illustrates a rising edge delayed by one beat, the rising edge of the “0” symbol may be delayed an indeterminate period of time, as long as the delay is at least equal to or greater than one beat. For example, a period of a microsecond or more, followed by a rising edge, may indicate a “0” symbol, where a rising edge within a period of time less than that may indicate a “1” symbol. FIG. 16C illustrates an exemplary symbol series “1011011” encoded according to the bright pulse encoding scheme illustrated in FIGS. 16A and 16B.

### EXEMPLARY BRIGHT PULSE FRAME STRUCTURE

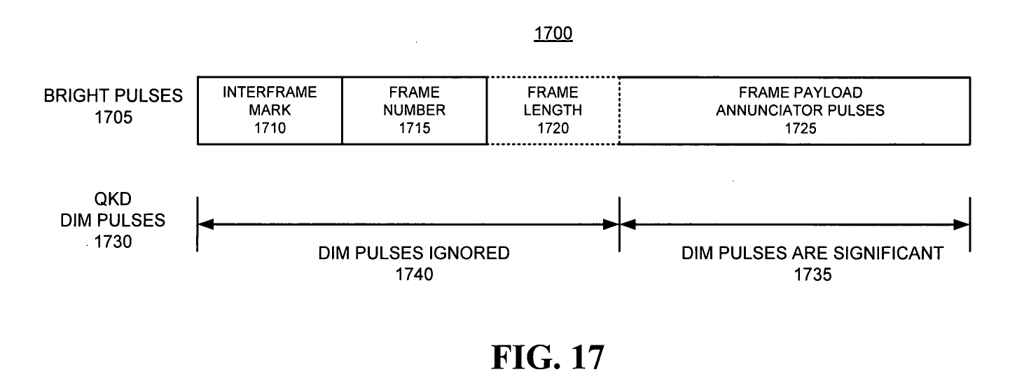

FIG. 17 illustrates an exemplary bright pulse frame 1700 consistent with principles of the invention. Multiple “bright pulses” 1705 may be transmitted by bright source 1342 of dim optical pulse transmitter 1110. Frame 1700 may include an interframe mark 1710, a frame number 1715, an optional frame length 1720 and frame payload annunciator pulses 1725. Interframe mark 1710 may include a specially designated sequence of bright pulses that indicates a start of a new frame. For example, a symbol sequence 00000000001 may indicate a start of a new frame. As an additional example, a symbol sequence 1111111110 may indicate the start of a new frame. Frame number 1715 may include a number of bits that indicate a sequence number of frame 1700. For example, frame number 1715 may include 32 bits binary encoded with frame 1700's frame number.

Optional frame length 1720 may include a number of bits that indicate a frame length of frame 1700. Frame length 1720 may include, for example, 32 bits binary encoded with a length of frame 1700. Frame payload annunciator pulses 1725 may include a number of pulses that identify the boundaries of the payload of frame 1700. In a fixed length frame, frame payload annunciator pulses 1725 may include, for example, 1024 bits all set to “1”. In a variable length frame, for example, frame payload annunciator pulses 1725 may include a number of bits set to “1” as determined by frame length 1720.

During the bright pulses of the frame payload annunciator pulses 1725, the dim pulses 1730 transmitted by dim optical pulse transmitter 1110 can be considered to be “significant”, and, thus, include the symbols of the frame payload (see 1735, FIG. 17). During the period of the frame spanning the interframe mark 1710, frame number 1715 and frame length 1720, any dim pulses transmitted by dim optical pulse transmitter 1110 can be considered insignificant and, thus, ignored (see 1740, FIG. 17).

### EXEMPLARY OLT CHANNEL ACCESS PROCESS

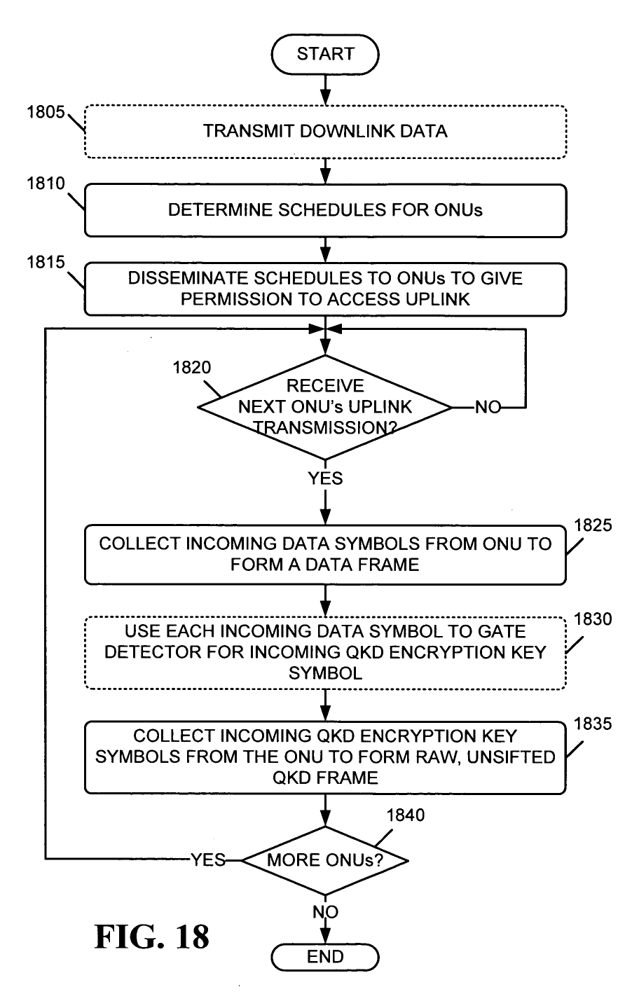

FIG. 18 is a flowchart that illustrates an exemplary process, consistent with principles of the invention, for channel access by OLT 420 to transmit downlink data to ONUs 425-1 through 425-N and to receive uplink data and encryption key symbols from ONUs 425-1 through 425-N.

The exemplary process may begin with the transmission of downlink data from OLT 420 to one or more ONUs 425 (optical block 1805). OLT 420 may forward data received from Internet 435, PSTN 440 or video network 445 via downlink transmission to one or more ONUs 425. OLT 420 may then determine transmission schedules for uplink channel access by the ONUs 425 (block 1810). The transmission schedules identify a time period during which each ONU 425 may transmit on the uplink to OLT 420. OLT 420 may disseminate the schedules to ONUs 425 to give permission to access the uplink (block 1815). OLT 420 may wait for the receipt of a next ONU's uplink transmission and when it is received (block 1820—YES), OLT 420 may collect incoming data symbols from the next ONU 425 to form a data frame (block 1825). The incoming data symbols may include data to be forwarded by OLT 420 to Internet 435, PSTN 440 and/or video network 445. The next ONU that OLT 420 should be expecting for uplink transmission may be designated by the previously disseminated schedule. OLT 420 may then use each incoming data symbol to gate detectors 1450 and 1460 for incoming QKD cryptographic key symbols (optional block 1830). Each data symbol may, thus, be transmitted in parallel with a corresponding QKD encryption key symbol across multi-drop optical network 415 and may be used for gating the detectors at dim optical pulse receiver 1210.

OLT 420 may collect incoming QKD encryption key symbols from the ONU to form a raw, unsifted QKD frame (block 1835). Encryption key symbols received by dim optical pulse receiver 1210 may be collected to form a raw QKD frame, such as, for example, receiver Qframe 1545 of FIG. 15. The encryption key symbols of the raw QKD frame may subsequently be processed using existing QKD protocols (e.g., sifting, eavesdropper estimation, error detection and correction, privacy amplification). If there are more ONUs in the disseminated transmission schedule (block 1840—YES), then the exemplary process may continue at block 1820 with the receipt of ONU uplink transmission from a next ONU in the disseminated transmission schedule. If ONUs 425-1 through 425-N have completed uplink transmission according to the disseminated transmission schedule, then the exemplary process may complete, or return to block 1805.

### EXEMPLARY ONU UPLINK CHANNEL ACCESS PROCESS

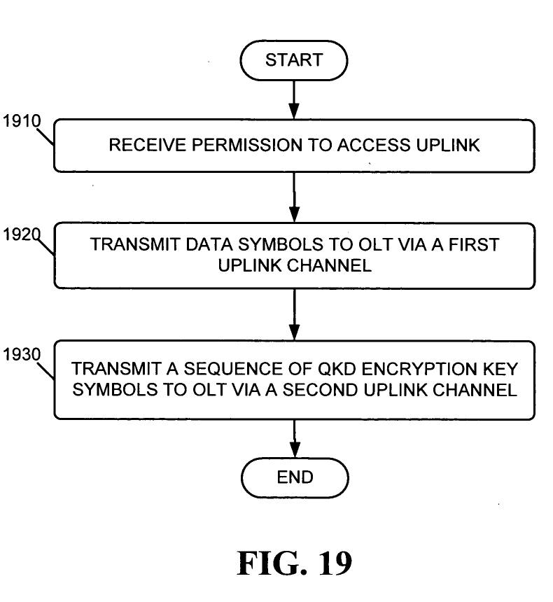

FIG. 19 is a flowchart that illustrates an exemplary process, consistent with principles of the invention, for uplink channel access between an ONU 425 and OLT 420. The exemplary process may begin with the receipt of permission to access the uplink to OLT 420 (block 1910). OLT 420 may disseminate a schedule to ONU 425 that grants ONU 425 channel access during a specific time period, while other ONUs 425 are granted channel access during other time periods. ONU 425 may transmit data symbols to OLT 420 via a first uplink channel (block 1920) based on the disseminated schedule. In the event that ONU 425 does not have any data that needs to be sent, ONU 425 may instead transmit “padding” data which OLT 420 may discard upon receipt. ONU 425 may transmit a sequence of QKD cryptographic key symbols to OLT 420 via a second uplink channel (block 1930) based on the disseminated schedule. Subsequent to block 1930, the exemplary process may complete, or return to block 1910.

### CONCLUSION

The foregoing description of exemplary embodiments of the invention provides illustration and description, but is not intended to be exhaustive or to limit the invention to the precise form disclosed. Modifications and variations are possible in light of the above teachings or may be acquired from practice of the invention. For example, while certain components of the invention have been described as implemented in software and others in hardware, other configurations may be possible.

While a series of acts has been described with regard to FIGS. 18 and 19, the order of the acts may vary in other implementations consistent with the invention. Also, non-dependent acts may be performed in parallel. No element, act, or instruction used in the description of the present application should be construed as critical or essential to the invention unless explicitly described as such. Also, as used herein, the article “a” is intended to include one or more items. Where only one item is intended, the term “one” or similar language is used. The scope of the invention is defined by the following claims and their equivalents. Further, the phrase “based on” is intended to mean “based, at least in part, on” unless explicitly stated otherwise.

What is claimed is:

1. A method, comprising:
receiving dim optical pulses from a plurality of subscriber units at a head-end or central office via a multi-drop optical network, wherein the dim optical pulses comprise one of single-photon optical pulses or weak, attenuated optical pulses; and
detecting the dim optical pulses at the head-end or central office.

2. The method of claim 1, wherein the multi-drop optical network comprises a passive optical network (PON).

3. The method of claim 2, wherein the PON comprises one of an ATM based PON, an Ethernet based PON, a broadband PON or a gigabit PON.

4. The method of claim 1, wherein the dim optical pulses convey encryption key symbols.

5. The method of claim 4, further comprising:
using the encryption key symbols to encrypt data sent from the head-end or central office to one of the subscriber units.

6. The method of claim 4, wherein a photon or photons of each of the dim optical pulses are phase modulated to encode the encryption key symbols.

7. The method of claim 4, wherein a photon or photons of each of the dim optical pulses are polarization modulated to encode the encryption key symbols.

8. A system, comprising:
an optical network unit connected to a multi-drop optical network, the optical network unit configured to:
transmit dim optical pulses via the multi-drop optical network using quantum cryptographic mechanisms to distribute encryption key symbols, wherein the dim optical pulses comprise one of single-photon optical pulses or weak, attenuated optical pulses; and
a head-end or central office connected to the multi-drop optical network and configured to:
detect the dim optical pulses from the optical network unit,
derive the encryption key symbols from the detected dim optical pulses, and
encrypt data transmitted to the optical network unit using the encryption key symbols.

9. The system of claim 8, wherein the multi-drop optical network comprises a passive optical network (PON).

10. The system of claim 9, wherein the passive optical network comprises one of an ATM based PON, an Ethernet based PON, a broadband PON or a gigabit PON.

11. A method, comprising:
determining transmission schedules for a plurality of optical network units connected to an optical line terminal via a multi-drop optical network;
disseminating the transmission schedules to the plurality of optical network units; and
receiving, at times corresponding to the disseminated transmission schedules, encryption key symbols from the plurality of optical network units via the multi-drop optical network using quantum cryptographic techniques.

12. The method of claim 11, wherein the encryption key symbols are received over a first channel via the multi-drop optical network.

13. The method of claim 12, further comprising:
receiving, at times corresponding to the disseminated transmission schedules, data from the plurality of optical network units via the multi-drop optical network.

14. The method of claim 13, wherein the data is received from the plurality of optical network units over a second channel via the multi-drop optical network.

15. The method of claim 14, wherein the first channel is a different optical wavelength than the second channel.

16. The method of claim 14, wherein the first channel is a different time slot than the second channel.

17. The method of claim 14, wherein the first channel is a different combined wavelength and timeslot than the second channel.

18. The method of claim 11, wherein receiving the encryption key symbols from the plurality of optical network units comprises:
receiving dim optical pulses from the plurality of optical network units, wherein the dim optical pulses comprise one of single-photon optical pulses or weak, attenuated optical pulses; and
decoding encryption key symbols from the received dim optical pulses.

19. The method of claim 11, wherein receiving encryption key symbols from the plurality of optical network units comprises:
receiving a different set of encryption key symbols from each of the plurality of optical network units.

20. The method of claim 19, further comprising:
encrypting data to send to one of the optical network units using a set of encryption key symbols received from the one of the optical network units; and
transmitting the encrypted data to the one of the optical network units.

21. A system, comprising:
a plurality of subscriber units that each includes a dim optical pulse transmitter configured to distribute encryption key symbols via quantum cryptographic mechanisms; and
a head-end or central office connected to the plurality of subscriber units via a multi-drop optical network, the head-end or central office including one or more dim optical pulse detectors configured to detect dim optical pulses encoded with the encryption key symbols from the plurality of subscriber units, wherein the dim optical pulses comprise one of single-photon optical pulses or weak attenuated optical pulses.

22. A method, comprising:
receiving permission to access an uplink from an optical line terminal;
transmitting data to the optical line terminal via a first uplink optical channel; and
transmitting encryption key symbols to the optical line terminal via a second uplink optical channel that is different than the first uplink optical channel.

23. The method of claim 22, wherein transmitting the encryption key symbols comprises:
transmitting dim optical pulses encoded with the encryption key symbols, the dim optical pulses comprising one of single-photon optical pulses or weak, attenuated optical pulses.

24. The method of claim 22, further comprising:
transmitting the data using bright optical pulses via the first uplink optical channel.

25. The method of claim 22, further comprising:
encrypting data on a downlink from the optical line terminal using the transmitted encryption key symbols.

26. A method, comprising:
obtaining data for transmission to a head-end or central office;
obtaining encryption key symbols for transmission to the head-end or central office; and
multiplexing dim optical pulses with bright optical pulses on an optical link connected to the head-end or central office, wherein the dim optical pulses comprise single-photon or weak attenuated optical pulses that are encoded with the encryption key symbols, wherein the bright optical pulses comprise optical pulses having a large number of photons and which convey the obtained data.

27. The method of claim 26, wherein multiplexing the dim optical pulses with the bright optical pulses comprises:
using time division multiplexing (TDM) to multiplex the dim optical pulses with the bright optical pulses on the optical link.

28. The method of claim 26, wherein multiplexing the dim optical pulses with the bright optical pulses comprises:
using wavelength division multiplexing (WDM) to multiplex the dim optical pulses with the bright optical pulses on the optical link.

29. The method of claim 26, wherein multiplexing the dim optical pulses with the bright optical pulses comprises:
using a combination of time division multiplexing (TDM) and wavelength division multiplexing (WDM) to multiplex the dim optical pulses with the bright optical pulses on the optical link.

30. A system, comprising:
means for receiving dim optical pulses from a plurality of subscriber units via a multi-drop optical network, wherein the dim optical pulses comprise one of single-photon optical pulses or weak attenuated optical pulses; and
means for detecting the dim optical pulses to determine encryption keys for encrypting data sent to the plurality of subscriber units.
